(19) United States
(12) Patent Application Publication
(10) Pub. No.: US 2002/0001383 A1
(43) Pub. Date: Jan. 3, 2002

(54) Cryptosystem using multivariable polynomials

(75) Inventor: Masao Kasahara, Minoo-city (JP)

Correspondence Address: Hogan & Hartson L.L.P., Suite 1900, 500 South Grand Avenue, Los Angeles, CA, 90071, US

(73) Assignee: MURATA MACHINERY LTD

(21) Appl. No.: 09/726,180

(22) Filed: Nov. 29, 2000

(30) Foreign Application Priority Data
Mar. 10, 2000 (JP) 2000-66226

(51) Int. Cl. H04L 9/30

(52) U.S. Cl. 380/30

(57) ABSTRACT

Let us consider a message M an element (m1,m2, . . . ,mk) in a Galois field GF (2^{k}), and multiply it by a product of polynomials β 1(α)-α t(α) into M(α).

M(α)=Mβ1(α)·Mβ2(α) . . . Mβt(α)

Combine a noise vector r(α) of n-k to M(α) in series so that the data is expanded into degree n. Next, they are transformed into Γ by permutation. Γ is multiplied by an element γ^{x} in the Galois field GF(2ⁿ) into cyphertext C(M), where γ is a primitive root of the multiplicative group of the Galois field GF(2ⁿ). Practically, when the message M is substituted for X in a public key C(X), the cyphertext C(M) is obtained. The cyphertext C(M) is multiplied by γ^{-x}, is applied to an inverse permutation, and the noise vector r(α) is separated. Then, the inverse element of the product of β1(α)-βt(α) is multiplied and is raised to an adequate index. Then the decrypted message is obtained.

### FIELD OF THE INVENTION

The present invention relates to a new cryptosystem and cryptographic communication that use the difficulty in solving multivariable polynomials.

### PRIOR ART

Cryptosystems using polynomials in multivariables have been proposed, for instance, by Matsumoto et al in “Public Quadratic Polynomial tuples for Efficient Signature Verification and Message-encryption”, Prop. of EUROCRYPT 88, Springer Verlag, Vol.20, and p.p.419-453. In those cryptosystems, elements in Galois fields are expressed in polynomial forms, and the messages, or the plaintext, are encrypted into coefficients of the polynomials. When each element of a message is considered a variable or an indeterminate, the message is considered multivariables, and respective degree's coefficients of a polinomial give new polynomials in multivariables. However, the security of such cryptosystems has not been clear. The present inventor has been aiming at enhancing the security of multivariable polynomial cryptosystems, and the resultant is the present invention.

### SUMMARY OF THE INVENTION

The object of the invention is to provide a novel and strong cryptosystem that uses multivariable polynomials and to provide a decryption method and a decryptor for decrypting enciphered text according to the cryptosystem.

Further object of the invention is to provide recording medium and propagated signal storing the decryption program.

In the present cryptosystem, we use multivariable polinomials in finite extensions of a prime field. We use for instance the following three elements:

1) Multiplying messages by polinomials and encrypting respective elements in the message into coefficients of the resultant new polinomials;

2) Adding noise to the messages and then applying an element in the symmetric group for scrambling the noise and the messages; and

3) Multiplying the messages by elements in the finite extension fields.

Practically enough security of the resultant cyphertext is obtained, if the nabove addition of noise to the messages and the subsequent permutation by the element in the symmetric group, and the above multiplication by the elements in the finite extension fields such that in respective degrees of the resultant polinomial in the extension fields, the messages and the noise are encrypted in a complex manner. For practical encryption, the encryption algorithm may be kept secret to persons encrypting their messages, and they can encrypt their messages simply by substituting their messages for indeterminates of polinomials. Thus we can consider the cyphertext polinomials of messages, and the cyphertext is highly secure. For instance, when we multiply our messages by polinomials in finite extension fields and express the products in polinomial forms in the extension fields, the coefficients of the product polinomials are given by new polinomials depending upon both the messages and the noise in a complex manner. However, the security for the cryptosystems using only the multiplication of the messages and the polinomials has not been confirmed.

When we add to the above multivariable polinomial cryptosystem, the combination with the noise and the subsequent scrambling, the security is remarkably enhanced. Further, when we add the multiplication by the elements in the extension fields after the scrambling between the messages and the noise, the security is further enhanced. Thus our improved cryptosystem is derived. According to the present cryptosystem, the characteristic features of the system do not appear during the encryption procedure. The features appear through decryption procedure, and procedures corresponding to the encryption algorithm become necessary during the decryption. Therefore, the decryption method and decryption device will be necessary for the practical use of the cryptosystem.

According to the invention, messages are considered elements in finite extension fields of prime fields. Hereinafter, finite extension fields are sometimes called extension fields, fields, etc. The cyphertext, obtained by substituting the messages for indeterminates of polinomials or by the evaluation of the polinomials at the messages, is multiplied by a first secret key (an element in the finite extension fields), and permutation by a second secret key in the elements of the cyphertext is performed such that the message (plaintext) corresponding parts and the noise will be separated. For breaking the present cryptosystem, both the first and second secret keys are necessary, and their candidates are very many. Further, for performing the multiplication by the first secret key, it is necessary to know the irreducible polinomials that have generated the finite extensions. Therefore, the present cryptosystem is highly secure.

Preferably, the first secret key is selected from powers of primitive roots of primitive polinomials in the finite extensions so that wide variety is possible for the first secret key with changes in the indices of the powers for the higher security. Further, multiplication by the powers of the primitive roots is easily done, and the decryption becomes easier.

Preferably, the message corresponding parts separated by the second secret key is further multiplied by a third secret key comprising a secret polinomial. Thus, for the decryption, multiplication by the first secret key, the permutation by the second secret key, and the multiplication by the third secret key are necessary, and if the third secret key would be stolen, irreducible polinomials used for the generation of the finite extension before adding the noise is necessary for the multiplication by the third secret key. Therefore, the security of the present system is very high.

Most preferably, after the multiplication by the third secret key, the power root of the product is calculated by a fourth secret key in such a way that the product is raised to an adequate degree's power. Thus, for the decryption, the multiplication by the first secret key, the permutation by the second secret key, the multiplication by the third secret key of a polinomial, and the power root operation by the fourth secret key are necessary. Without the fourth secret key, the cyphertext can be decrypted just into complex polinomials of respective elements in the messages, so the security of the present cryptosystem is further enhanced.

According to the present cryptosystem, the decryption program may for instance be distributed through information networks, as CD-ROMs and IC cards.

### BRIEF DESCRIPTION OF THE DRAWING

FIG. 1 is a block diagram showing an encryptor and a decryptor, and their interconnection according to the embodiment of the invention.

FIG. 2 is a flowchart showing an encryption algorithm in the embodiment.

FIG. 3 is a flowchart showing a practical process for the encryption in the embodiment.

FIG. 4 is a flowchart showing a decryption algorithm in the embodiment.

FIG. 5 shows an example of the distribution of the decryption program through an information network in the embodiment.

FIG. 6 is a block diagram showing an encryption and decryption device according to the embodiment.

### THE BEST EMBODIMENT

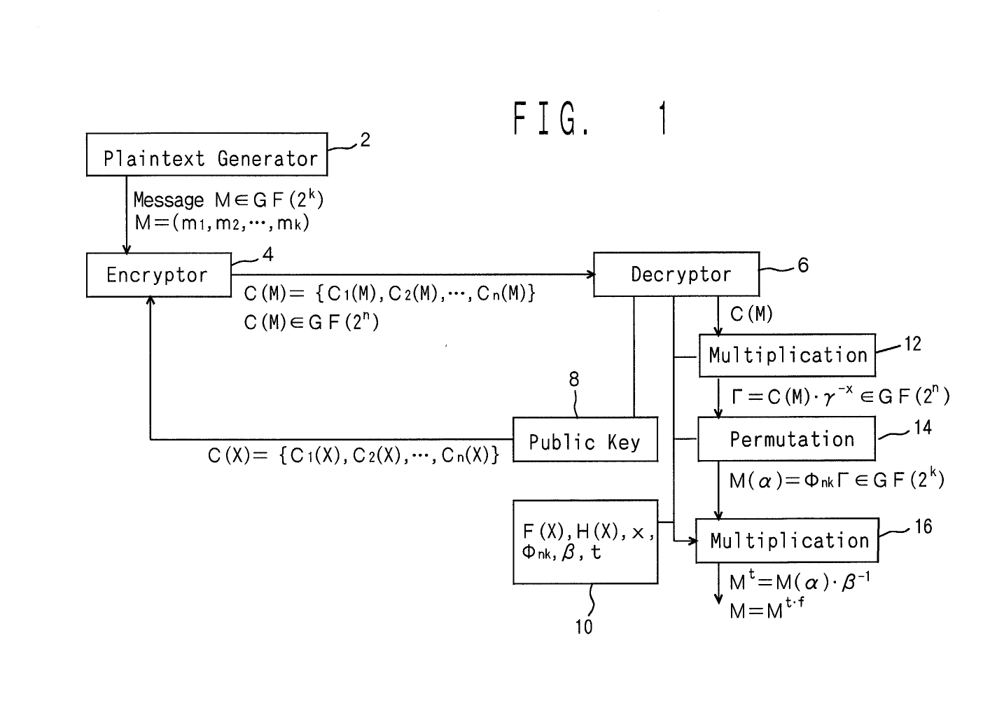

FIGS. 1 - 6 show the best embodiment. First, major terms in the embodiment are described. GF(2^{k}) and GF(2ⁿ) show Galois fields, respectfully. The prime subfields contained in the Galois fields have characteristic of a prime number or 0, and when the characteristic is 0, the prime field is the field Q of rationale numbers. While the characteristic of the prime fields may be a prime number or 0, we prefer 2 for easier computation in digital information processing devices. The Galois fields GF(2^{k}) and GF(2ⁿ) are examples of the finite extensions of the prime field of characteristic 2. The value of k is, for instance, among 64 and 16384, and we assume k 1024 in the embodiment. The value of n is greater than that of k, for instance, about 2k, preferably 128 to 32768, and we assume n 2048 in the embodiment.

F(X) is a primitive polynomial in the Galois field GF(2^{k}) and has degree k. Similarly, H(X) is a primitive polynomial in the Galois field GF(2ⁿ) and has degree n. For making the decryption easier, we select both F(X) and H (X) from primitive polynomials in the respective extension fields. However, F(X) may be an irreducible polynomial in the Galois field GF(2^{k}). Similarly, H(X) may be an irreducible polynomial in the Galois field GF(2ⁿ). α is one of the roots of the polynomial F(X), and so F(α)=0. γ is a primitive root of H(X), and so H(γ)=0. X is a natural number, and γ^{x} is an non-zero element of the Galois field GF(2ⁿ).

M means a message and is 1024 bit data in the embodiment. We consider M a vector comprising 1024 elements (m1-mk), where k is for instance 1024, and consider also M an element of the Galois field GF(2^{k}). In this specification, the set N of natural numbers comprises positive integers and 0. For the encryption, we use t pieces of polynomials, β1(α), β2(α), . . . , βt(α), all of which are elements in the Galois field GF(2^{k}), and transform the message M into cyphertext at the first stage M(α) by the following equation (1).

M(α)=Mβ1(α)·Mβ2(α) . . . Mβt(α) modF(α) (1)

We call the resultant M(α) the message corresponding part and denote the product of β1(α) . . . βt( α) simply by β. The operation by the equation (1) is performed in the Galois field GF(2^{k}), and since it is obvious that modular operations are performed, when obvious in context, we will sometimes omit the notification for modular operations.

A noise r(α) of degree (n-k) is randomly produced and combined, for instance, at the end of the message corresponding part M(α). The degree of the noise r(α) is for instance 1024, and obviously the noise r(α) is for instance 1024 bit long. An element in the symmetric group (the permutation group) is applied to the message corresponding part and the noise, and the elements of them are completely scrambled. We call the resultant Γ which has order n and is an element in the Galois field GF(2ⁿ). We denote the above mapping from M(α) to Γ by Φ⁻¹nk and denote the inverse mapping of Φ⁻¹nk by Φ nk that will be used during the decryption. We call the transformation between M(α) and Γ substitution without referring to encryption or decryption, since whether it means encryption or decryption will be obvious in context.

We multiply Γ by γ^{x} and get a resultant polinomial C. The respective coefficients of the polynomial C is by themselves polynomials depending upon both the noise and the message corresponding part in a complex manner. We sometimes write the polynomial C as a set of coefficients Ci of respective degrees of C so that C={Ci(M) }. C is the final cyphertext. For emphasizing that C is a function of the message M, we will sometimes write the cyphertext text C as C(M).

The above encryption algorithm may be performed more simply without reference to the encryption algorithm. Since C(X)={Ci(X)} is disclosed as the public key, a sender substitutes M for X in the public key and thus gets the cyphertext Ci(M)(i=1−n). Each element of the cyphertext Ci(M) is a polinomial in the elements (m1-mk) in the message M.

The secret keys are F(X), H(X), x (or γ^{x}), Φnk, β, and t which is a positive integer. β is represented by the following equation (2),

β=β1(α)·β2(α) . . . βt(α) (2)

We select γ from the primitive roots of H(X), so any non-zero elements in the Galois field GF(2ⁿ) can be represented as γ^{-x}, and therefore the multiplication by γ^{-x} is easily performed. Let f be a natural number (index) such that M^{tf}=M. If t and 2^{k}−1 are mutually prime, there exists such a natural number f. Therefore, gcd(t, 2^{k}−1), the greatest common divisor between t and 2^{k}−1, is preferably 1.

In the following, networks mean information networks, and digital information processing devices mean computers and cryptographic communication chips having logic circuits therein. Recording media mean those retrievable by computers and decryption chips, and the propagating signals mean those running through networks, etc.

FIG. 1 shows an encryptor 4, a decryptor 6, and the interconnection between them through a network such as the Internet. The encryptor 4 receives the public key C(X) from a public key memory 8 provided in the decryptor 6 and encrypts the message M produced by a plaintext generator 2 provided in the encryptor by the public key. The message M is an element in the Galois field GF (2^{k}), composed of (m1,m2, . . . ,mk), and is k bit long. For the encryption of the message M into the cyphertext C(M) with the public key C(X), the message M is substituted for X in each element Ci(X)(i=1−n) in the public key C(X) of degree n. The resultant cyphertext C(M) is an element in the Galois field GF(2ⁿ).

In the decryptor 6, a secret key memory 10 is provided for storing the primitive polynomial F(X) in the Galois field GF(2^{k}), the primitive polynomial H (X) in the Galois field GF(2ⁿ), the value of the primitive root γ in the Galois field GF(2ⁿ), if plural primitive roots are present, the Value x in γ^{x}, the permutation Φ nk in the symmetric group for separating the message corresponding part and the noise, the polynomial β used for the multiplication by the equation (1), and t, the index of the power of M, etc.

Multiplication means 12 multiplies the cyphertext C(M) by γ^{-x} in the Galois field GF(2ⁿ), and C(M) is transformed into Γ C(M)γ^{-x}. Substitution means 14 applies Φ nk in the symmetric group to Γ so that the message corresponding part M(α) and the noise are separated from Γ. Second multiplication means 16 multiplies the message corresponding part M(α) by the inverse β⁻¹ of the polynomial β such that M^{t}=M(α)β⁻¹. Then, M^{t} is further raised to the f-th power, and since M^{tf}=M, the plaintext is obtained. When t and 2^{k}−1 are mutually prime, the above f, a positive integer, is present.

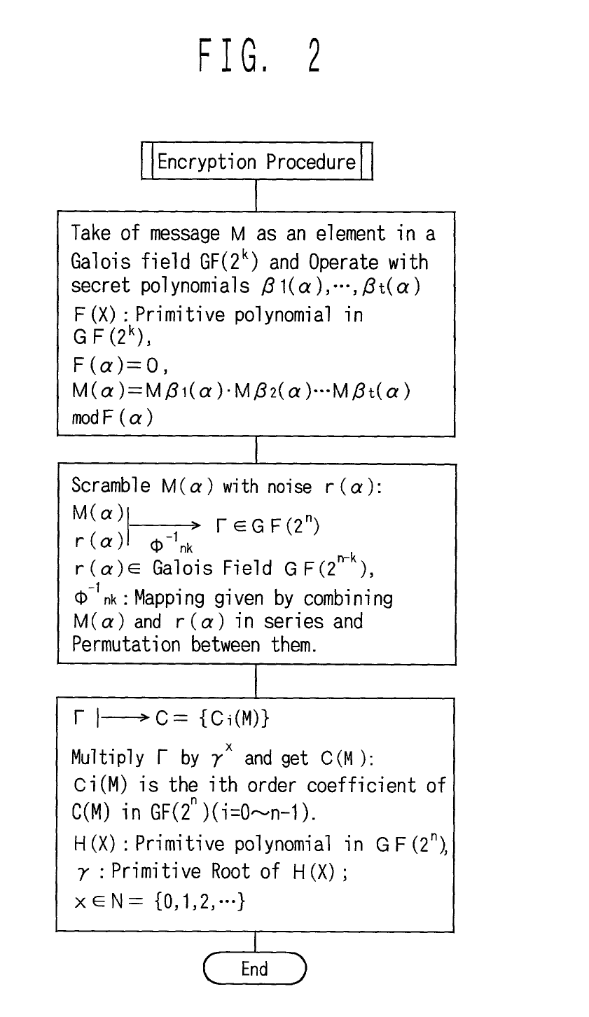

FIG. 2 shows a practical encryption algorithm. The message M, for instance 1024 bit long and may already include some noise in it, is deemed as an element in the Galois field GF(2^{k}), and processed by the equation (1) so that the message corresponding part M(α) is resultant.

M(α)=Mβ1(α)·Mβ2(α) . . . Mβt(α) mod F(α) (1)

The message corresponding part M(α) is a polynomial of degree at most k−1, and in each coefficient of the polinomial, the elements m1-mk in the message M are scrambled in a complex manner. The coefficients of the polinomial are respectively deemed as polynomials of degree t in variables m1-mk. When the message corresponding part M(α) is used as the final ciphertext, the security has not been confirmed. Therefore we enhance the security as follows.

The message corresponding part M(α) is scrambled with the noise r (α) of degree n−k. For instance, first the noise r(α) is adjoined at the end of the message corresponding part M(α), and then the element Φ⁻¹nk in the symmetric group is applied to them. Thus they are transformed into the element Γ in the Galois field GF(2ⁿ).

Next, Γ is multiplied by γ^{x}, and the elements in the message corresponding part M(α) and the elements in the noise r(α) are combined in a complex manner in each coefficient of the polynomial C in the Galois field GF(2ⁿ). Here γ is a primitive root of the primitive polynomial H(X), and hence any elements not 0 in the Galois field GF(2ⁿ) may be expressed as γ^{x} for some x. The resultant cyphertext C is very secure.

In the embodiment, three steps have been performed in the following order: First the operation by the equation (1), then the addition of the noise r(α) and the permutation (scramble), and finally the multiplication by γ^{x}. However, they may be performed in a different order. For instance, first the scramble between the message M and the noise r may be done, and then, the multiplication by the polynomial and the other multiplication by the power of the primitive root may be done. Alternatively, first the multiplication by the power of the primitive root may be done, then the scramble with the noise r may be done, and finally the multiplication by the polynomial may be done. Moreover, since the present cryptosystem is very secure, the addition of and permutation with the noise and just one of the group comprising the first multiplication by the polynomial and the second multiplication by the power of the primitive roots may be performed.

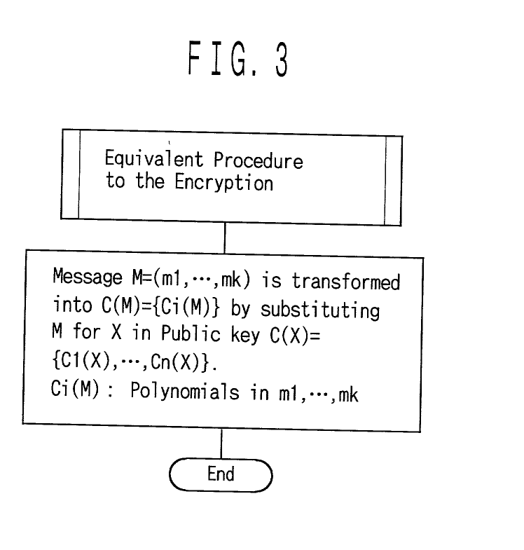

While FIG. 2 shows the encryption algorithm in detail, practically the sender does not need to know the encryption algorithm. In the practical encryption, as shown in FIG. 3, the public key C(X) comprising elements Ci(X)(i=1−n) is disclosed, where the indeterminate X has the same data length to the message M. When a sender substitutes the message M for the indeterminate X, then the cyphertext C(M) is obtained. Therefore, the encryption is very easily performed, and the public key C(X) is a strong one-way function.

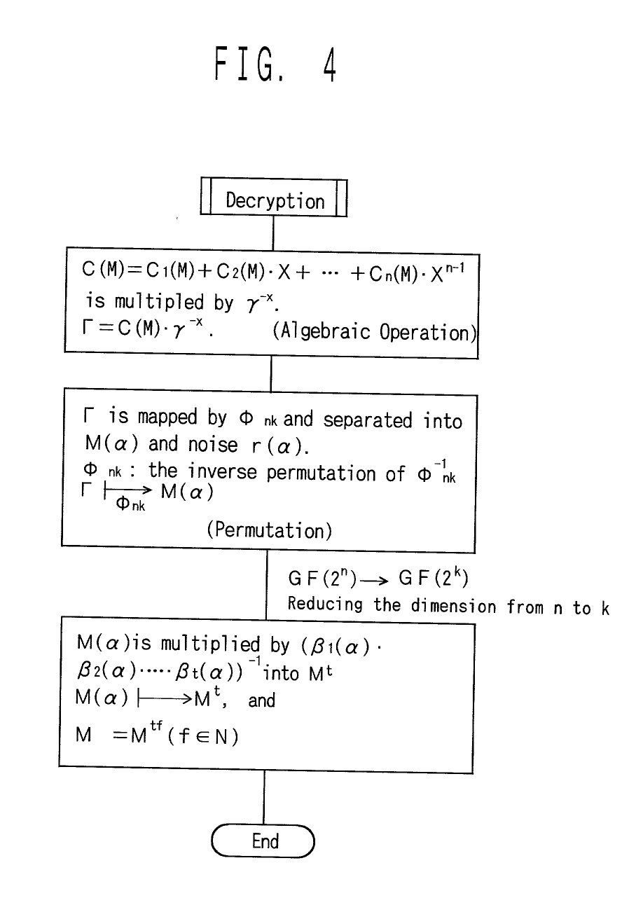

FIG. 4 shows the decryption algorithm. The cyphertext C(M) received by the decryptor 6 is multiplied by γ^{-x}, and thus Γ is obtained. Since γ^{-x} is an element in the Galois field GF(2ⁿ), the multiplication is easily performed. Next, mapping Φ nk, which is the inverse of Φ⁻¹nk already used for the addition of the noise and the subsequent scrambling, is applied to Γ so that Γ is transformed into the message corresponding part M(α) and the noise r(α) separately. The noise is discarded. During this step, the orders of the Galois fields decrease from 2n to 2k. Next, the message corresponding part M(α) is multiplied by the inverse β⁻¹ of the product β of the t-pieces polynomials β1(α)−βt(α) in the equation (1), and hence M(α) is transformed into Mt. If t and 2^{k}−1 are mutually prime, there exists some natural number f such that M^{tf}=M. As a result, the message M is decrypted.

FIG. 5 shows the distribution of decryption programs through a network 24. A distribution station is denoted by 20, an a recipient station is denoted by 22. The recipient station 22 requires to a distribution station 20 to send the decryption program, and the distribution station 20 sends the decryption program, the public key, and secret keys as a signal propagating through the network 24 to the recipient station 22. The decryption program distributed is one for performing the algorithm in FIG. 4.

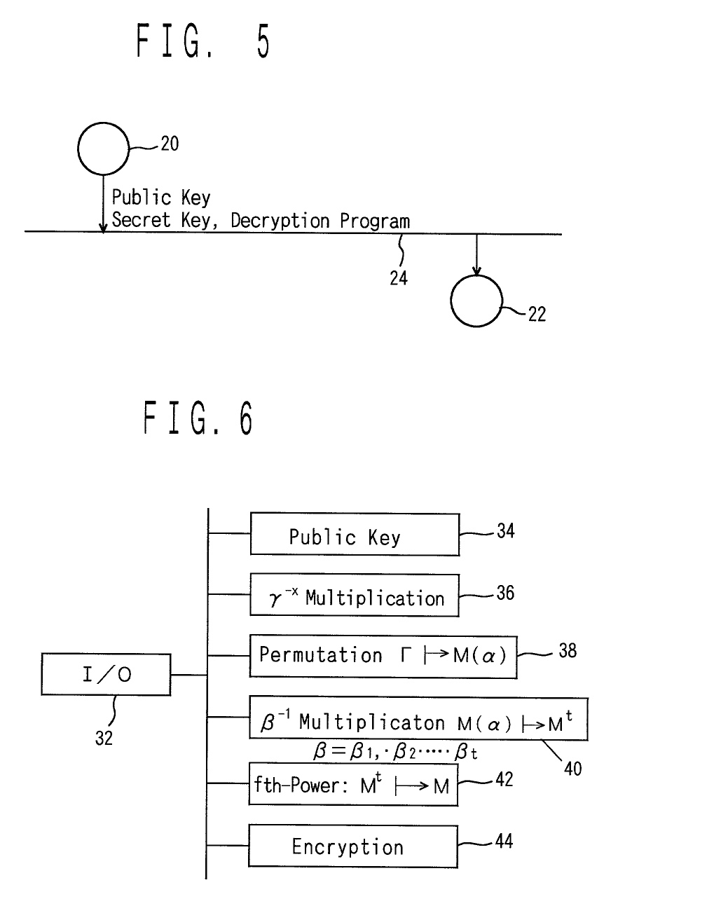

FIG. 6 shows an example of encryption and decryption device 30. An I/O 32 communicates with the outside or is connected to an outside computer and so on. A public key memory 34 stores the public key C(X) and discloses the key to the public. Multiplication means 36 stores the value of γ^{-x} and multiplies the cyphertext by γ^{-x}. Substitution means 38 stores the element in the symmetric group for transforming Γ into the message corresponding part M(α), and thus transforms Γ into M(α). Second multiplication means 40 stores the polynomial β⁻¹ and multiplies the message corresponding part M(α) by the polynomial β⁻¹ such that Mt is obtained. The resultant M^{t} is further raised to the f-th power by raising means 42 and decrypted to the original message M. Encrypting means 44 encrypts the message M produced in the encryption and decryption device 30. These means 36-44 may easily be realized by a combination of the registers and the logic gates and so on, or by means of computer software installed into an adequate computer.

While the embodiment has been described with an example for the public key cryptosystem, the cryptosystem according to the invention may be designed as a secret key cryptosystems. In that case, if the secret keys such as the primitive polynomials, the value for x, the element Φ nk in the symmetric group for the separation between the message corresponding part and the noise, the polynomial β, and the value of t, and the length of M are renewed properly, the longevity of the cryptosystem is enhanced. While the embodiment has shown the specific example, alterations may be performed. For instance, the secret keys themselves do not need to be stored necessarily, and other data equivalent to the secret keys or those can be transformed into the secret keys may be stored in place of the secret keys.

1. A decryption method with usage of a digital information processing device for decrypting cyphertext corresponding to plaintext and expressed by an element of a finite extension field of a prime field, wherein said element has a plurality of sub-elements, comprising:
a step for multiplying the cyphertext by a first secret key; and
a step for permuting the sequence of the sub-elements in the cyphertext in such a way that said sub-elements are separated into a part corresponding to the plaintext and noise.

2. A decryption method according to claim 1, wherein said cyphertext is obtained by substituting the plaintext for an indeterminate of a first polynomial.

3. A decryption method according to claim 1, wherein said first secret key is one of powers of a primitive root of a primitive polynomial in the finite extension field.

4. A decryption method according to claim 1, further comprising a step for multiplying said part corresponding to the plaintext by a third secret key comprising a second polinomial to a product.

5. A decryption method according to claim 1, further comprising a step for obtaining a power root of said product.

6. A decryption method for decrypting cyphertext corresponding to plaintext and expressed by an element of a finite extension field of a prime field with usage of a digital information processing device, wherein said element has a plurality of sub-elements, comprising:
sending to said digital information processing device a computer program including a sub-program for multiplying the cyphertext by a first secret key, and a sub-program for permuting the sequence of the sub-elements in the cyphertext in such a way that said sub-elements are separated into a part corresponding to the plaintext and noise; and
making said digital information processing device decrypt the cyphertext according to said computer program.

7. A decryption method according to claim 6, wherein said cyphertext is obtained by substituting the plaintext for an indeterminate of a first polynomial.

8. A decryptor for decrypting cyphertext corresponding to plaintext and expressed by an element of a finite extension field of a prime field, wherein said element has a plurality of sub-elements, comprising:
a multiplication means for multiplying the cyphertext by a first secret key; and
a permutation means for permuting the sequence of the sub-elements in the cyphertext in such a way that said sub-elements are separated into a part corresponding to the plaintext and noise.

9. A decryptor according to claim 8, wherein said cyphertext is an evaluation of a first polynomial at the plaintext.

10. A decryptor according to claim 8, wherein said multiplication means multiplies the cyphertext by one of powers of a primitive root of a primitive polynomial in the finite extension field as the first secret key, and further comprising a means for multiplying said part corresponding to the plaintext by a third secret key comprising a second polinomial into a product and for obtaining a power root of said product.

11. A recording medium, for decrypting cyphertext corresponding to plaintext and expressed by an element of a finite extension field of a prime field comprising a plurality of sub-elements, retrievable by a digital information processing device, and for making the digital information processing device perform:
a step for multiplying the cyphertext by a first secret key; and
a step for permuting the sequence of the sub-elements in the cyphertext in such a way that said sub-elements are separated into a part corresponding to the plaintext and noise.

12. A propagating signal, for decrypting cyphertext corresponding to plaintext and expressed by an element of a finite extension field of a prime field comprising a plurality of sub-elements, and storing codes retrievable by a digital information processing device and for making said digital information processing device perform:
a step for multiplying the cyphertext by a first secret key; and
a step for permuting the sequence of the sub-elements in the cyphertext in such a way that said sub-elements are separated into a part corresponding to the plaintext and noise.
